(19) United States
(12) Patent Application Publication
(10) Pub. No.: US 2024/0152665 A1
(43) Pub. Date: May 9, 2024

(54) EVALUATING A THREE-DIMENSIONAL MODEL OF A DESIRED OBJECT

(71) Applicant: Magnus Metal Ltd., Tzora (IL)

(72) Inventors: Yoav Miller, Rehovot (IL); Ido Holcman, Rehovot (IL)

(73) Assignee: Magnus Metal Ltd., Tzora (IL)

(21) Appl. No.: 17/983,819

(22) Filed: Nov. 9, 2022

(51) Int. Cl. G06F 30/20; G06T 17/10

(52) U.S. Cl. CPC G06F 30/20; G06T 17/10; G06F 2111/04

(57) ABSTRACT

A method for evaluating a three-dimensional (3D) model of a desired object based on casting system manufacturing constraints, the method may include (i) obtaining the 3D model of the desired object; wherein the 3D model comprises vertexes and angular information regarding angular relationships between the vertexes; (ii) virtually partitioning the 3D model to slices; (iii) generating a 3D model of a casting system-compliant object; wherein the generating comprises determining for each slice, based on casting system manufacturing constraints and on the 3D model of the desired object, (a) one or more mold regions associated with the slice, and (b) one or more object regions defined by the one or more mold regions, to be formed by molten metal processing; and (iv) responding to the generating of the 3D model of the casting system-compliant object

### TECHNICAL FIELD

The application generally relates to the field of casting parts. More specifically, the application relates to the field of the additive casting of parts.

### BACKGROUND

Additive manufacturing (AM) techniques are replacing traditional casting that involves the global production of molds and the global application of molten metal into fully-produced global molds. The full production of molds often involves three-dimensional (3D) printing. The additive manufacturing of metal objects is a complex and time-consuming process—and there is a growing need to predict the outcome of additive manufacturing before starting to additively manufacture a new item.

### SUMMARY

According to an aspect of the invention, there is provided a method, system, and non-transitory computer-readable medium for evaluating a 3D model of a desired object.

According to an aspect of the invention, there is provided a method for evaluating a three-dimensional (3D) model of a desired object based on casting system manufacturing constraints, the method may comprise: obtaining the 3D model of the desired object; wherein the 3D model comprises vertexes and angular information regarding angular relationships between the vertexes; virtually partitioning the 3D model into slices; generating a 3D model of a casting system-compliant object; wherein the generating comprises determining for each slice, based on casting system manufacturing constraints and on the 3D model of the desired object, (a) one or more mold regions associated with the slice, and (b) one or more object regions defined by the one or more mold regions, to be formed by molten metal processing; and responding to the generating of the 3D model of the casting system-compliant object.

The casting system manufacturing constraints may comprise at least one out of molding process constraints, mold machining constraints, or molten metal constraints. The mold machining constraints may comprise milling process constraints. The milling process constraints may comprise one or more constraints from a group consisting of (1) milling device accessibility constraints and (2) milling device size constraints. The molten metal constraints may comprise one or more constraints from a group consisting of (1) a dimension of a drop of molten metal, (2) an area of a spread of a drop of the molten metal, (3) a dimension of a stream of molten metal, and (4) feasible trajectories of a stream of molten metal. The mold constraints may comprise one or more constraints from a group consisting of (1) viscosity of mold material, (2) shape constraints of mold material, (3) binding agents selective deposition constraints; mold powder particles provision constraints, (4) mold powder removal constraints, (5) mold material deposition constraints. The casting system manufacturing constraints may comprise at least one out of (1) molding process voxel constraints, (2) mold voxel machining constraints, and (3) molten metal voxel constraints. The casting system manufacturing constraints may comprise voxel size and orientation constraints.

The method may further comprise detecting non-manufacturable 3D model elements that cannot be manufactured under the casting system manufacturing constraints. The operation of responding may comprise generating an alert regarding the detecting non-manufacturable 3D model elements. The method may further comprise compensating for the non-manufacturable 3D model elements. The method may further comprise ignoring the non-manufacturable 3D model elements.

According to another aspect of the invention there is provided a non-transitory computer-readable medium for evaluating a three-dimensional (3D) model of a desired object based on casting system manufacturing constraints, the non-transitory computer-readable medium stores instructions for obtaining the 3D model of the desired object; wherein the 3D model comprises vertexes and angular information regarding angular relationships between the vertexes; virtually partitioning the 3D model into slices; generating a 3D model of a casting system-compliant object; wherein the generating comprises determining for each slice, based on casting system manufacturing constraints and on the 3D model of the desired object, (a) one or more mold regions associated with the slice, and (b) one or more object regions defined by the one or more mold regions, to be formed by molten metal processing; and responding to the generating of the 3D model of the casting system-compliant object.

According to an aspect of the invention there is provided a computerized evaluation device for evaluating a three-dimensional (3D) model of a desired object based on casting system manufacturing constraints, the computerized evaluation device comprising a memory; and a processing device coupled to the memory, the processing device to perform operations comprising: obtaining the 3D model of the desired object; wherein the 3D model comprises vertexes and angular information regarding angular relationships between the vertexes; virtually partitioning the 3D model into slices; generating a 3D model of a casting system-compliant object; wherein the generating comprises determining for each slice, based on casting system manufacturing constraints and on the 3D model of the desired object, (a) one or more mold regions associated with the slice, and (b) one or more object regions defined by the one or more mold regions, to be formed by molten metal processing; and responding to the generating of the 3D model of the casting system-compliant object.

The determining operation may comprise the finding that a facet that is located at a certain location and is formed by a set of vertexes of the 3D model does not comply with an orientation constraint of a voxel located at a corresponding certain location.

The operation of the finding of the facet may be followed by evaluating whether the facet can be manufactured by the casting system by (a) dispensing mold to the voxel that is located at the corresponding certain location, (b) removing excess material from the voxel to provide a partial voxel, and (c) providing molten metal to a gap formed by the removing of the excess material.

The operation of responding may comprise generating difference information between the 3D model of the desired object and the 3D model of the casting system-compliant object. The operation of responding may comprise storing the 3D model of the casting system-compliant object.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIGS. 2-13 illustrate an example of 3D models of objects, problems related to the manufacturing of desired objects, and solutions to overcome some manufacturing limitations;

FIG. 14 illustrates an example of an evaluation system and a casting system; and

FIG. 15 illustrates an example of an evaluation system.

### DETAILED DESCRIPTION

According to embodiments of the invention, there are provided systems and methods for the evaluation of a three-dimensional (3D) model of a desired object in the context of digitally planned and controlled additive metal casting. The fabrication of the metal (or metallic) object is planned as a sequence of multiple production operations, executed layer-by-layer: the current production layer, including mold regions and object regions constructed on top of previously produced production layers. Fabrication planning starts with the evaluation of a three-dimensional (3D) model of the desired object in light of the manufacturing constraints of the casting system. Casting system manufacturing constraints may relate to the construction of mold regions and metal regions.

### Digitally Planned and Controlled Additive Metal Casting

A currently-produced production layer is a layer that is being produced during a production iteration. The currently-produced production layer may include one or more current mold regions and one or more current object regions. Once production of a currently-produced production layer is completed—the currently-produced production layer may be regarded as a previously-produced production layer.

Upon completion of mold construction at a specific production layer, object fabrication in that production layer starts by depositing molten metal into object regions defined by the mold regions. In some embodiments, one or more molten metal deposition device travels over a building plane and deposit molten metal in a plurality of fabrication areas. In some embodiments, one or more heating units travel over the building plane according to a building plan and heat the fabrication areas before and/or after molten metal deposition. The production process continues one production layer after the other.

Examples of casting systems and/or casting methods are illustrated in US patent application publication serial number 20200206810 and/or in U.S. patent application Ser. Nos. 17/744,686, 17/748,069—all being incorporated herein by reference.

### Evaluating a Three-Dimensional Model of the Desired Object

Additive casting differs from traditional casting in manufacturing benefits and constraints and, consequentially, with respective design evaluation and optimization.

In digital additive casting, the fabrication of various metal (or metallic) objects with various features is readily facilitated. For example, in traditional casting techniques, such as die casting using permanent molds, the fabrication of sharp corners and other sharp features is not recommended. In die casting, sharp corners impact metal flow during casting. Further, sharp corners cause high-stress concentrations and high heat concentrations, which may lead to shorter die (mold) life. Accordingly, die-casting product geometry optimization strives for curved, rounded corners with longer inner and outer radii and uniform walls (fillets). In contrast, the fabrication of sharp corners by additive manufacturing by depositing molten metal into mold regions, one production layer after the other, may resolve metal flow, high-stress concentrations, and high heat concentration issues.

Holes and windows are other design optimization examples. In die casting, holes and windows may interfere with the metal flow, which can be resolved in die casting using bridges. Digitally planned and controlled additive metal casting resolves metal flow issues associated with holes and windows, e.g., by constructing, in each production layer, mold material in the holes and windows areas. As will be described herein, the production of the first mold region of the desired hole or a window of the final structure may be challenging in cases this mold region is dispensed over a metal region (‘mold over metal’ production scenario).

In some embodiments, during the production of the currently-produced production layer, portions of the previously-produced production layer are heated. The heating of portions of the previously-produced production layer before molten metal deposition contributes to the bonding of the added molten metal of the currently-produced production layer to the previously-produced production layer. Portions of the currently-produced production layer may be heated after molten metal deposition so as to affect the cooling profile of the currently-produced production layer. The previously-produced production layer and/or the currently-produced production layer may be heated near a melting point, up to the melting point, and beyond. Thus, a mold region that sits on an object region may experience floating forces due to partial or complete surface melting. The floating forces depend on the specific weights of the object and mold.

In some green state mold dispensing embodiments, the viscous mold material may sag under its own weight. The sagging phenomena is considered during planning, especially if more than one mold dispensing iteration is performed prior to metal deposition. For example, three green state mold layers, each at 2 mm height, may be dispensed to generate a 6 mm-height cavity for metal deposition. This production scenario is denoted herein as ‘Mold over Mold’.

The deposition of molten metal may be achieved in various flow patterns, including a plurality of discrete droplets (dripping), a stream of drops, and a burst. Each of the dripping, stream, and bursts is characterized by a drop diameter, a drop shape, a drop size, a spread area of a drop, and a feasible trajectory of a drop. Depending on metal viscosity and flow pattern, molten metal deposition is characterized by an ‘effective metal resolution’. The ‘effective metal resolution’ defines the minimal object feature that can be manufactured in a production layer.

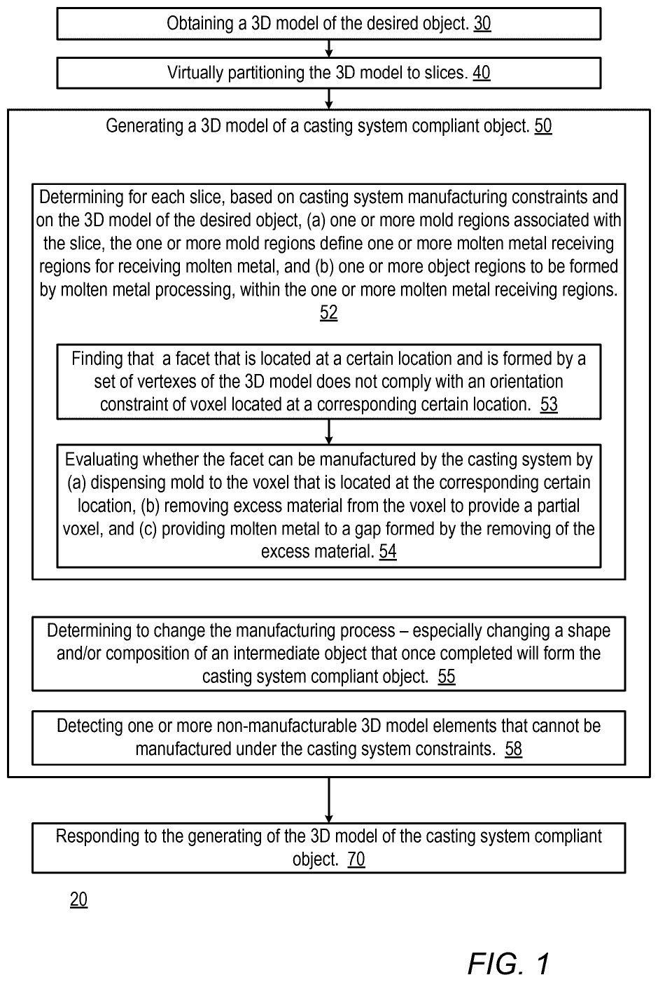

FIG. 1 illustrates an example of method 20 for evaluating a 3D model of a desired object based on casting system manufacturing constraints. The casting system may be an Additive Manufacturing (AM) casting system.

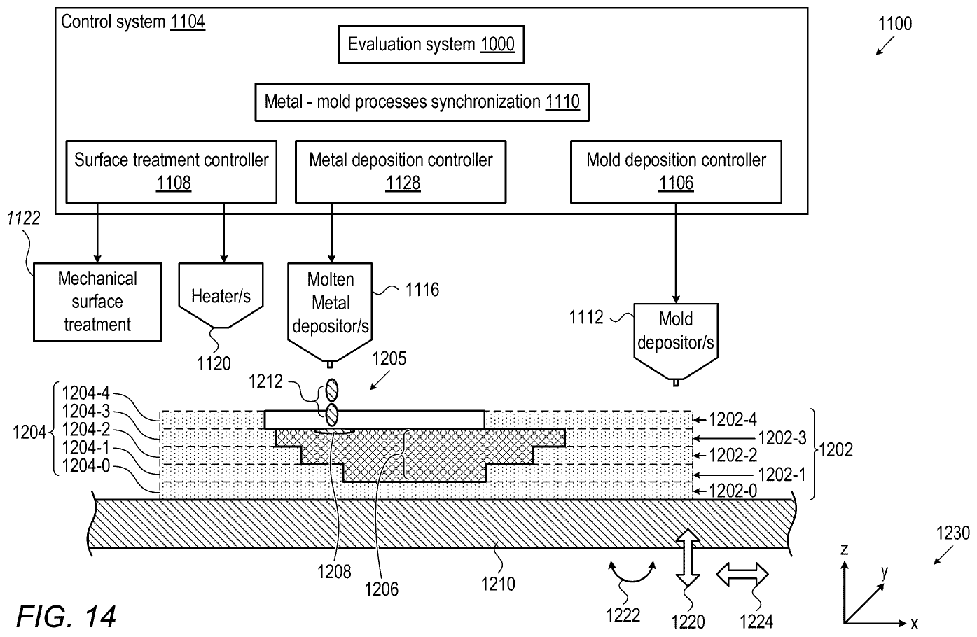

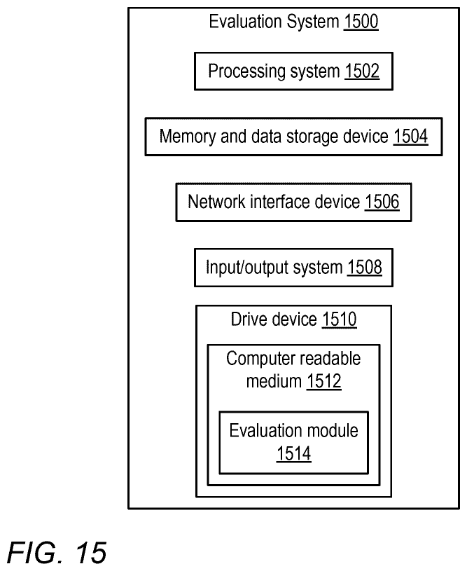

Method 20 may be executed by one or more computerized evaluation systems. The computerized evaluation system may be a part of the casting system or may not be a part of the casting system. Aspects of the computerized evaluation systems and the casting systems according to embodiments of the invention will be described with reference to FIGS. 14-15.

Method 20 may start with operation 30 of obtaining a 3D model of the desired object. The 3D model includes vertexes and angular information regarding angular relationships between the vertexes. The 3D model may be represented in any manner—for example, a point cloud, a facets model, and the like. The 3D model of the desired object may be of any format—for example, an STL file or another CAD type of file.

Operation 30 may also include pre-processing the 3D model of the desired object—for example, smoothing, filtering, de-noising, and the like.

Operation 30 may be followed by operation 40 of virtually partitioning the 3D model into slices. The outcome of operation 40 is multiple virtual 3D slices of the 3D model.

One or more slice parameters (for example, width) may be determined by a user or in any manner.

It should be noted that method 20 may evaluate different relevant values of relevant different processing parameters and select these values—wherein the selection of the values can be made in any manner—random, pseudo-random, based on one or more deterministic rules, based on previous models generated by method 20, based on user preferences, and the like.

Method 20 may provide multiple candidates for 3D models of casting system-compliant objects. The user may select a candidate out of the multiple candidates.

Operation 40 may be followed by operation 50 of generating a 3D model of a casting system-compliant object.

Operation 50 may include operation 52 of determining for each slice, based on casting system manufacturing constraints and on the 3D model of the desired object, (a) one or more mold regions associated with the slice, the one or more mold regions define one or more molten metal receiving regions for receiving molten metal, and (b) one or more object regions to be formed by molten metal processing, within the one or more molten metal receiving regions.

The casting system manufacturing constraints may include at least one out of the following constraints:
i. Molding process constraints.
ii. Mold machining constraints.
iii. Metal-related constraints.

The casting system manufacturing constraints may be related to the casting system and/or to the casting methods applied by the casting system.

A casting system constraint may be applicable to the entire 3D model of the casting system-compliant object—or may be a local constraint applicable to one or only some of the voxels of the 3D model of the casting system-compliant object.

The mold machining constraints may include milling process constraints such as milling device accessibility constraints (for example, whether the drill bit may reach a specific voxel) and/or milling device size constraints (for example—what is the diameter of the drill bit).

The milling device accessibility may be determined by the manner in which the milling device is moved (number of degrees of freedom, range of movement) and the presence of other components of the casting system (for example—molten metal processing system, any system related to the mold) that may limit the access of the milling device. Different systems and/or units of a casting system may have their own movement elements, such as robotic arms, rails, and the like.

‘Effective metal resolution’ constraints: The deposition of molten metal may be achieved in various flow patterns, including a plurality of discrete droplets (dripping), a stream of drops, and a burst. Each of the dripping, stream, and bursts is characterized by a drop diameter, a drop shape, a drop size, a spread area of a drop, and a feasible trajectory of a drop. Depending on metal viscosity and flow pattern, molten metal deposition is characterized by an ‘effective metal resolution’. The ‘effective metal resolution’ defines the minimal object feature that can be manufactured in a production layer.

The molten metal constraints may include as well as a dimension of a drop of molten metal and/or an area of a spread of the drop of the molten metal and/or a dimension of a stream of molten metal and/or feasible trajectories of a stream of molten metal and/or feasible trajectories of a drop of molten metal.

In case the desired feature size is below the ‘effective metal resolution’, one or more of the following operations may be performed: (1) deviation from the design of the desired object, for example, by widening the respective feature size so as to bring it above the ‘effective metal resolution’ parameter; (2) affecting metal-related parameters such as viscosity (e.g., by adding appropriate inoculants or increasing metal temperature), target deposition temperature, target pre-heating temperature, flow pattern, flow rate, drop deposition trajectory and more; and if none of the above resolve metal resolution or is otherwise unacceptable—the desired object as a whole or in part, may be classified as non-compliant.

It is assumed that the provision of molten metal may exhibit one or more of these constraints (for example, the metal resolution—resolution obtained by molten metal provision per se—may not be smaller than the dimension of the drop of molten metal). It should be noted that these constraints may be, in some cases, at least partially overcome by other processes, such as machining.

The mold constraints may include viscosity of mold material and/or mold material deposition constraints and/or shape constraints of mold material and/or binding agent selective deposition constraints, and/or mold powder particles provision constraints, and/or mold powder removal constraints.

Some of the mold constraints may relate to the mold material, and some other mold constraints may relate to the accessibility of any system related to mold provision and/or mold removal.

For example—the viscosity of the mold material may introduce at least a minimal amount of curvature to the mold regions.

The casting system manufacturing constraints may include molding process voxel constraints and/or mold voxel machining constraints and/or molten metal voxel constraints and/or voxel size constraints, and/or voxel orientation constraints.

At least some of the voxel constraints may refer to the shape and/or size of the voxel. For example—the size of the voxel may determine—especially when machining of the voxel is not feasible—the resolution of the manufactured item.

Operation 52 may include finding (operation 53) that a facet that is located at a certain location and is formed by a set of vertexes of the 3D model does not comply with an orientation constraint of a voxel located at a corresponding certain location.

Operation 53 may be followed by operation 54 (of operation 52) of evaluating whether the facet can be manufactured by the casting system by (a) dispensing mold to the voxel that is located at the corresponding certain location, (b) removing excess material from the voxel to provide a partial voxel, and (c) providing molten metal to a gap formed by the removing of the excess material.

Operation 50 may include operation 55 of determining to change the manufacturing process—especially changing a shape and/or composition of an intermediate object that, once completed, will form the casting system-compliant object.

Operation 50 may include operation 58 of detecting one or more non-manufacturable 3D model elements that cannot be manufactured under the casting system manufacturing constraints.

Operation 50 may be followed by operation 70 of responding to the generating of the 3D model of the casting system-compliant object.

Operation 70 may include at least one out of the following operations:
i. Generating an alert regarding the detected non-manufacturable 3D model elements and/or compensating for the non-manufacturable 3D model elements.
ii. Ignoring the non-manufacturable 3D model elements.
iii. Generating difference information between the 3D model of the desired object and the 3D model of the casting system-compliant object.
iv. Storing the 3D model of the casting system-compliant object and/or transmitting the 3D model of the casting system-compliant object.
v. Suggesting changing (or sending any indication about the change) of the manufacturing process—especially changing a shape and/or composition of an intermediate object that, once completed, will form the casting system-compliant object.
vi. Providing information regarding different stages in the manufacturing process—for example, on a slice-to-slice basis, on one or more intermediate objects formed during the manufacturing process, and the like.
vii. Providing information regarding multiple candidates of 3D models of casting system-compliant objects. The user may be allowed to select a candidate.

Method 20 may be executed in an iterative manner.

After a certain iteration—the method may receive feedback from the user—for example, to change one or more portions of the desired object and/or of a casting system-compliant object—and a later iteration may take into account the feedback—for example by attempting to comply with any request and/or requirement and/or command included in the feedback.

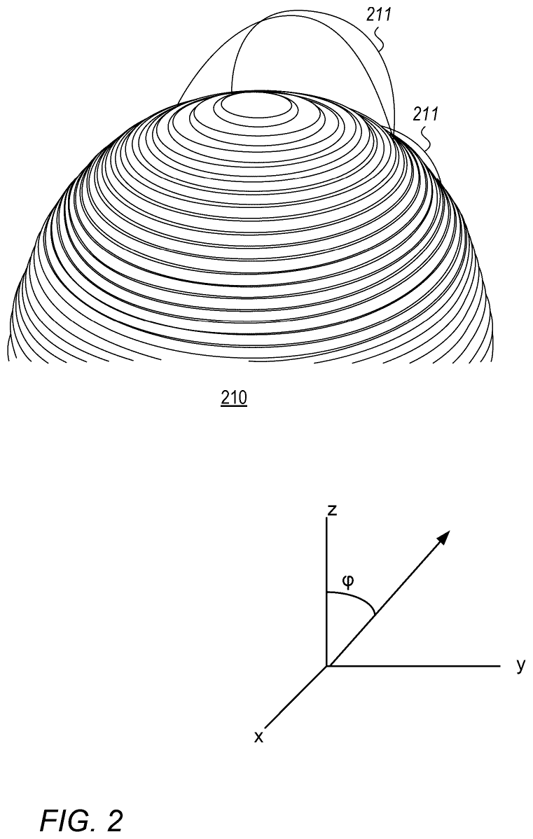

FIGS. 2-12 illustrate an example of desired objects, some of the problems related to the manufacturing of molds required for providing the desired objects, and some of the solutions that may assist in overcoming the problems.

FIG. 2 illustrates an example of a casting system-compliant object 210 that differs from a sphere-shaped desired object. The casting system is prevented from manufacturing a perfect sphere-shaped object—and the casting system-compliant object includes steps 211 that indicate gaps in the formation near the top of the sphere—due to limitations regarding the milling tool phi angle ((p)—the angle in relation to the z-axis. The casting system may be constrained from milling at certain phi angles, and this results in the stair-step shape of the compliant object.

The manufacturing of curved and spherical objects in additive manufacturing techniques and the resultant stair-step effect on accuracy—are known. An example can be found in Chapter 2—planning, of a Dissertation, Shape Deposition Manufacturing, ausgeführt zum Zwecke der Erlangung des akademischen Grades eines Doktors der technischen Wissenschaften eingereicht an der Technischen Universität Wien, Fakultät für Elektrotechnik, Von Dipl.-Ing. Robert Merz Sparkassenstr. 7, A-5020 Salzburg, Matr.Nr. 8426325, geboren am 15.03.1966 in Salzburg. Begutachter: O. Prof. Dipl.-Ing. Dr. techn. DDr. hc. Fritz Paschke and O. Prof. Dipl.-Ing. DDr. Helmut Detter, Wien, am 16. Mai 1994, which is incorporated herein by reference.

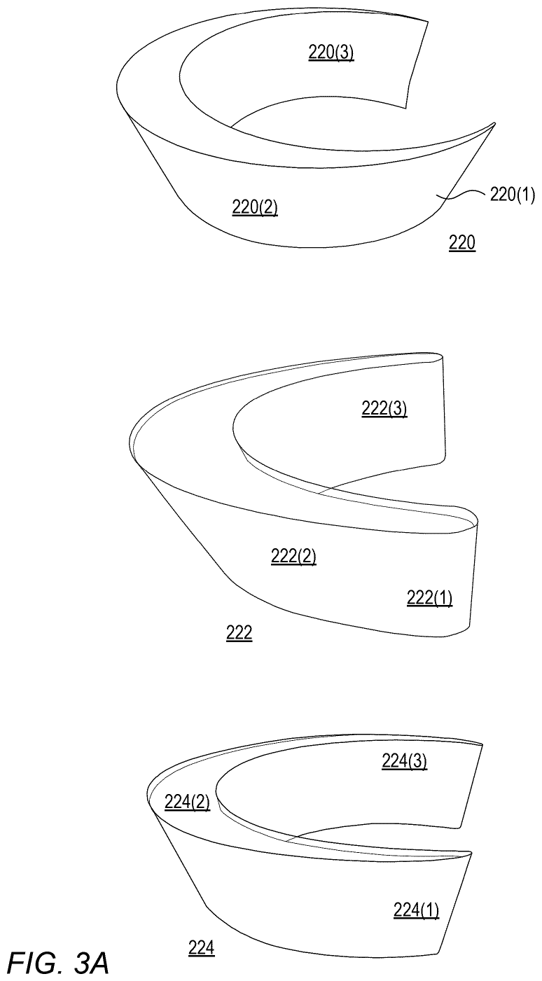

FIG. 3a illustrates an example of casting system-compliant objects 222 and 224 that differ from a moon-shaped desired object 220. The central portion 220(2) is thick enough to manufacture, but the edge regions 220(1) and 220(3) may be too thin and may not be formed due to surface tension. Note that edge regions 220(1) and 220(3) do not appear in any one of the casting system-compliant objects 222 and 224. Casting system-compliant object 222 includes central portion 222(2) and rounded edge portions 222(1) and 222(3) that are formed, e.g., by using a 6 mm diameter milling tool for mold region preparation. Casting system-compliant object 224 includes central portion 224(2) and rounded edge portions 224(1) and 224(3) that are formed by using, e.g., a 2 mm diameter milling tool for mold region preparation.

FIG. 3b illustrates an example of desired part 271 versus a casting system-compliant object 279. The sharp tip 272 of the desired part 271 may not be manufactured due to one or more of the following casting system manufacturing constraints: (i) in the case of mold construction by dispensing viscous mold material—mold paste minimal radius 273 that cannot form an ideal pointed edge (tip 272); (ii) in the case of mold surface treatment by milling—a milling tool limitation, such as minimal milling tool diameter 274.

In some embodiments, casting system manufacturing constraints may be overcome, e.g., by selecting an appropriate dispensing nozzle or affecting the mold paste minimal radius (for example, affecting paste viscosity), or selecting an appropriate milling unit for mold region surface treatment. In some embodiments, the manufacturing limitation results in the generation of a compliant object (objects 222 or 224 shown in FIG. 3a). In some embodiments, the manufacturing limitation results in the identification of a non-feasible part of the desired object (part 297 shown in FIG. 3b). An appropriate indication may be generated, for example, for a user. Alternatively, the identification of a part as non-feasible may be determined automatically.

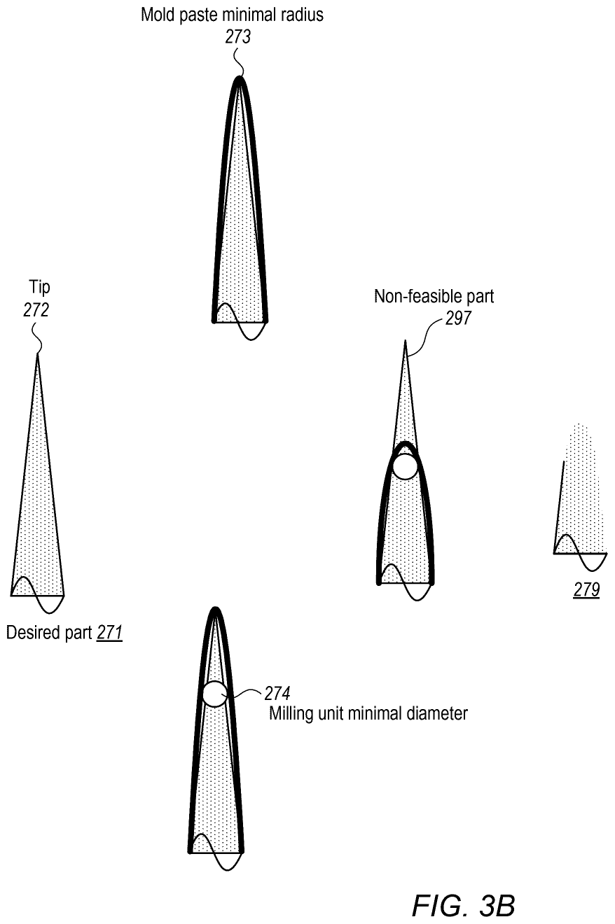

FIG. 4 illustrates an example of a desired object 230 having a thin portion 230(2) that is located between thicker portions 230(1) and 230(3). Thin portion 230(2) has a width W and may be too thin for creation by metal casting. A thicker metal portion with a width larger than W may be formed and then milled up to the desired width W. Alternatively, the thickness of the thin portion may be increased to at least a minimal thickness (minimal W) that can be manufactured by additive metal casting.

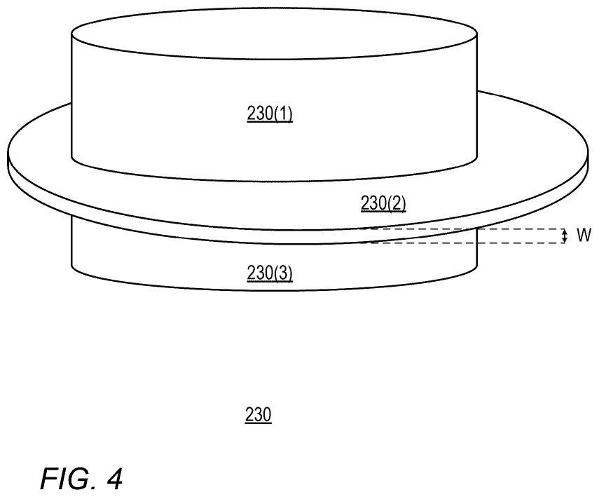

FIG. 5A and FIG. 5B illustrate examples of ‘mold over metal’ manufacturing scenarios, showing an interim production stage. As defined by the object design, mold regions 291 and 292 may each be covered, in the next production layers, by additional mold regions, for example, constituting together an object hole or window place holder (not shown). In the current production layer after the construction of the mold regions of the current production layer—including, e.g., mold regions 291 and 292—is complete, the deposition of molten metal starts.

Manufacturing scenario shown in FIG. 5A: in some embodiments, before depositing molten metal in the current production layer, the previously-produced metal region—being a part of solid metal bulk 295—is pre-heated. Heated metal 332—a part of the surface of solid metal bulk 295, is shown. In some embodiments, heated metal 332 is heated to below-melting temperature. In other embodiments, heated metal 332 is heated to a melting temperature (e.g., 1150 deg. Celsius for gray iron) and above.

Manufacturing scenario shown in FIG. 5B: in some embodiments, molten metal is deposited into the current production layer, giving rise to molten metal 333. In some embodiments, molten metal 332 is deposited at a melting temperature (e.g., 1150 deg. Celsius for gray iron). In other embodiments, molten metal 333 is heated to an above-melting temperature (e.g., superheating).

In other manufacturing scenarios (not shown), mold regions 291 and 292 may experience lifting forces in response to both pre-heating of the previously-produced production layer and deposition of molten metal (or superheated metal).

In either of the above-illustrated manufacturing scenarios, mold region 292 experience a lifting force and may lose its stability and may float, move, crack, or brake, while mold region 291, designed with a larger base area, may endure the lifting force exercised by the heated metal. The entirety of the bottom of mold region 292 is located above the molten metal. Only a part of the bottom of mold region 291 is in contact with the heated metal 332 or molten metal 333, while another part of the bottom is supported by the solid metal bulk 295. It should be noted that mold region 291 may be subjected to a lifting force that may lift mold region 291—even if a part of the bottom of mold region 291 is supported by solid metal. The lifting force is caused due to the difference in density between the molten metal and the mold regions.

Various examples for reducing and avoiding risks associated with ‘mold over metal’ manufacturing scenarios are illustrated below. The evaluation system may evaluate whether a certain ‘mold over metal’ element (for example, a base region of a certain mold element such as the so-called inserts, bridges, partial bridges, and the like), required for generating the desired object, may lose its stability (e.g., may break or float) without assistance or additional support. If there is a risk that the mold element will lose stability (e.g., will float in response to pre-heating and/or molten metal deposition) then one or more of the following operations may be performed: (1) setting a building plan that reduces the lifting forces acting on the ‘mold over metal’ element—for example by interlacing between the fabrication areas adjacent to the ‘mold over metal’ element to thereby apply interlaced heating (applying a specific deposition sequence); (2) selectively reducing the target temperature for pre-deposition heating or post-deposition heating near the ‘mold over metal’ element; (3) overhead support—using additional support such as an external holding element that may hold the ‘mold over metal’ element from above; (4) deviation from the design of the desired object, for example, widening the ‘mold over metal’ element; (5) adding a metal surface treatment operation (e.g., milling) after metal deposition and before starting the mold construction of the next production layer; and, if none of the above reduces floating and breaking risk or is otherwise unacceptable—the desired object as a whole or in part, may be classified as non-compliant.

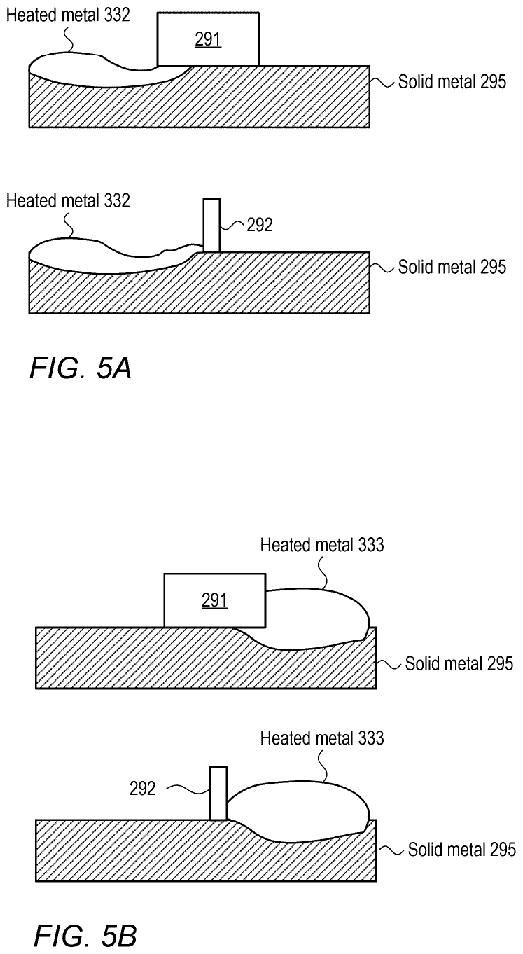

FIG. 6 illustrates examples of desired objects such as desired object 241, desired object 242, desired object 243, and desired object 244. Desired objects 241-244 include an upper recess 241(1), 242(1), 243(1), and 244(1), respectively. The upper recess 241(1), 242(1), 243(1), and 244(1) should be free of metal. Thus, during production, upper recesses 241(1), 242(1), 243(1), and 244(1) should be filled with mold material. The production of desired objects 241-244 involves ‘mold over metal’ production scenarios. The respective mold regions, including circumference mold elements (constructing the cylindrical cavity into which molten metal will be deposited) and the ‘mold over metal’ elements required for the production of Desired objects 241-244—are not shown.

As shown with respect to desired object 241: the first to third production layers (PL1-PL3) do not include ‘mold over metal’ elements. In the fourth production layer (PL4), the first portion of recess 241(1) is formed—a ‘mold over metal’ element. In the fifth and sixth production layers (PL5, PL6) the construction of the recess continues, however, with no ‘mold over metal’ element.

‘Mold over metal’ evaluation for desired object 241: depending on the type of object metal, mold material, and the geometry of desired object 241, the mold element corresponding to the recess in the fourth production line is wide enough and will not break and float.

‘Mold over metal’ evaluation for desired object 242: depending on the type of object metal, mold material, and the geometry of desired object 242, the mold element corresponding to the recess in the fourth production line is too narrow and will break and float. Thus, a corrective operation, as discussed above with reference to FIG. 5, is needed.

‘Mold over metal’ evaluation for desired object 243: the mold structure required for the fabrication of recess 243(1) has a “zig-zag” geometry and is supported from both sides by the object structure. In production layer PL4, the respective ‘mold over metal’ element will experience a non-symmetric lifting force which may break the ‘mold over metal’ element.

‘Mold over metal’ evaluation for desired object 244: the mold structure required for the fabrication of recess 244(1) is attached to the circumference mold structure (not shown) at one side. However, in production layer PL4, the respective ‘mold over metal’ element—being narrow and long, will experience a lifting force at its non-supported side and will break and float.

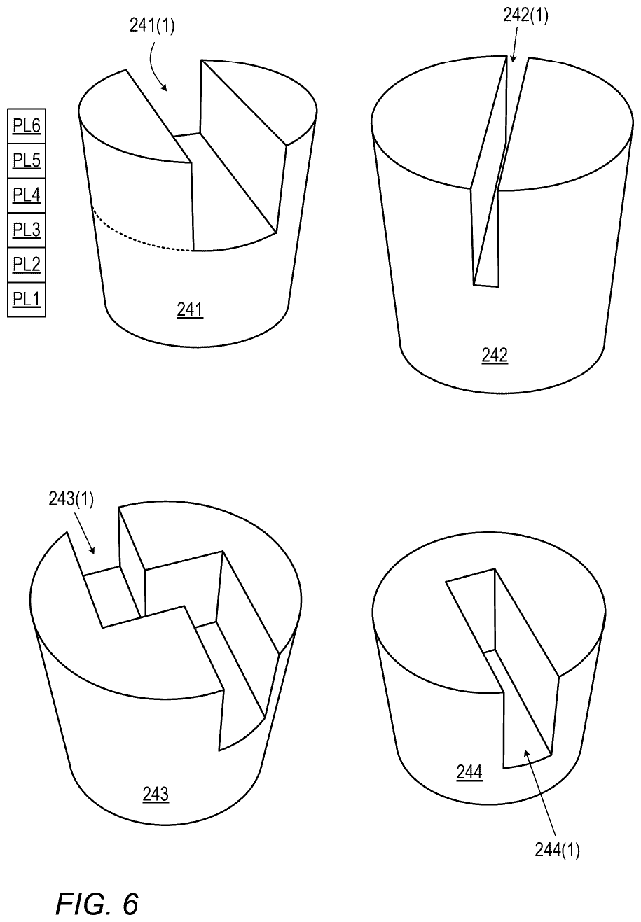

FIG. 7 illustrates an example of a compliant object corresponding to desired object 241 of FIG. 6. Two production phases in the manufacturing design of the compliant object corresponding to desired object 241 are shown. Production phase 251 shows the object region CO and the mold regions of production layers 1-4, required for constituting the cylindrical mold structure MS of desired object 241 up to production layer PL4. The mold structure MS is composed of two mold zones—Mold Zone 1 and Mold Zone 2, but this is not necessarily so. Production phase 252 shows the addition of the mold element corresponding to recess 241(1) of FIG. 5, in production layer PL4—which is a ‘mold over metal’ element.

In the example of FIG. 7, the various mold elements constituting the mold regions of a production layer differ from each other in one or more parameters: mold zone 1—metal facing zone—faces the metal and shapes it. In the case of in-situ mold construction, mold zone 1 may be dispensed as a dense, smooth mold paste. Mold zone 1 may undergo surface treatment to further prepare its sidewalls to face the metal. Two non-metal adjacent zones are shown in production phase 252: mold zones 2a and 2b, which support the mold zone 1 region. Note that mold zone 2a (Mold Zone 2 of production phase 251) and 2b may be made from the same material as mold zone 1—however, this is not necessarily so. Note that the mold zones may be dispensed using different dispensing plans: for example, mold zone 1 may be denser compared to mold zones 2, 2a, and 2b. Consequently, the dispensing of the non-metal adjacent mold zones may be faster comparing the dispensing of the metal-facing zone—thereby improving the overall production throughput. Further, mold zone 2b may be denser compared to mold zone 2a. The specific dispending plan and mold region density for the ‘mold over metal’ elements may take into consideration the lifting forces expected to act on it.

In some cases (e.g., gray iron and ceramic-based mold material), the specific weight of the object material—metal—is higher relative to the lighter mold material (for example, X2, X3). In other cases (e.g., aluminum and ceramic-based mold material), the specific weights of the object and mold material may be of the same order. Depending on the properties of the object and mold material that are used, altering the specific weights of either or both of the object and mold material at selected locations (e.g., near ‘mold over metal’ elements) may resolve non-compliant ‘mold over metal’ production scenarios. The specific weights of either or both of the object and mold material may be altered, for example, by applying localized heating and/or curing, by localized addition of material to the mold region to thereby increase its specific weight, and more.

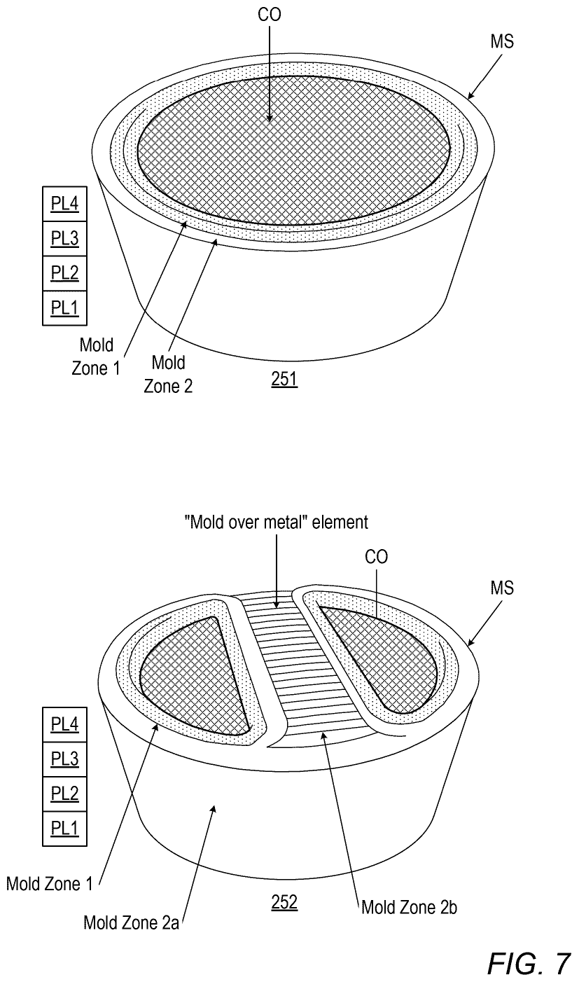

FIG. 8 schematically illustrates cross sections of various phases 301, 302, and 303 of a stack of production layers of an object—starting from the provision (301) of a stack of production layers that includes a base plate that supports (n−4)′th till (n−1)′th production layers including mold regions and the object regions (metal regions). The mold regions are shown each with two mold layers (two mold dispending iterations); however, this is not necessarily so.

Phase 302 illustrates the formation (302) of a ‘mold over metal’ element in the form of bridge 321 in the n′th production layer, above the (n−1)′th metal region prior to metal deposition in the n′th production layer.

Phase 303 illustrates the floating (303) of bridge 321 over molten metal 332, the molten metal drop 331 that is deposited during the formation of the metal region in the n′th production layer, and also illustrates lifting forces 330.

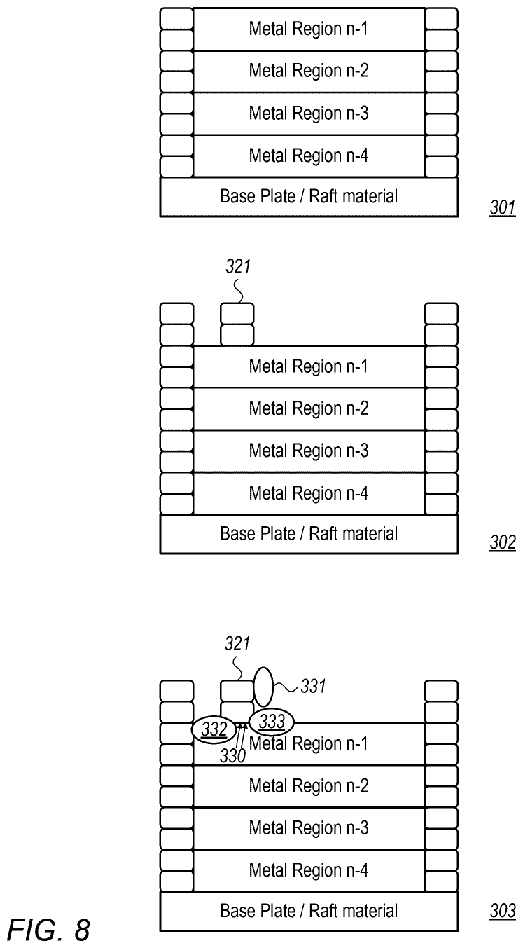

In some embodiments involving non-compliant mold over metal structures, the production sequence may be altered by first casting the metal region and later building the ‘mold over metal’ element by metal milling and mold filling. FIG. 9 schematically illustrates phases 304, 305, and 306 in which the metal region in the n′th production layer is formed (phase 304), a hole 334 for receiving the mold bridge is milled in the metal region (phase 305), and the mold bridge 331 (starting by a first part 321(1) of the bridge) is placed into the hole 334 (phase 306).

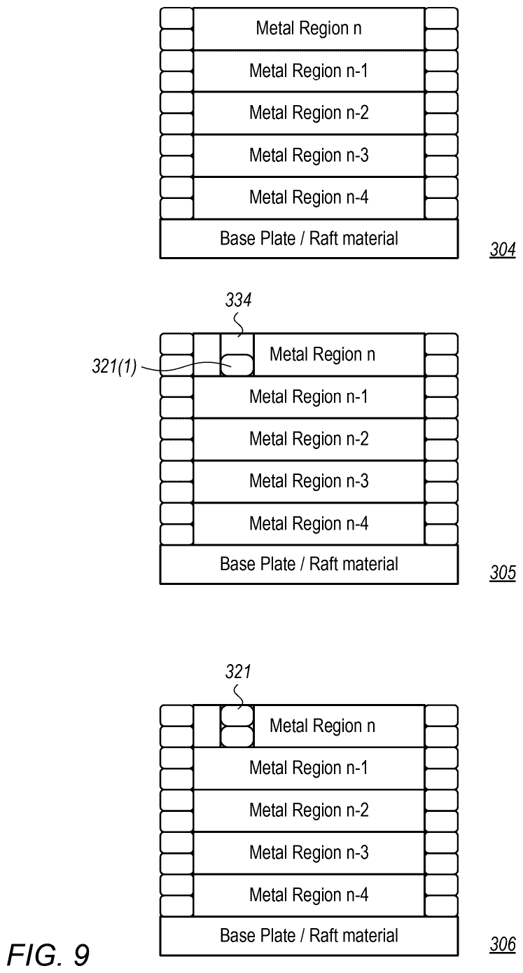

FIG. 10 illustrates an example of phases 307 and 308 in which an additional mold region in the form of bridge 322 is formed over bridge 321 of FIG. 9. In phase 307, bridge 322 is placed over bridge 321. Bridge 322 is not a ‘mold over metal’ element and is not expected to experience as severe lifting forces as bridge 321. In phase 308, molten metal is deposited into the object region of the n+1 production layer.

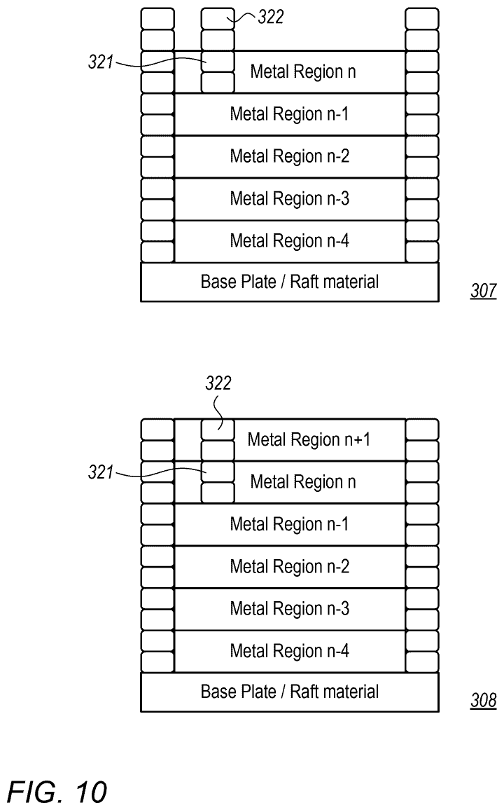

FIG. 11 illustrates an example of an alternative phase 309 in which no additional bridge 322 is formed over bridge 321. Upon removal of the mold structure at the end of production, a hole will be formed in the place occupied by bridge 321 during production.

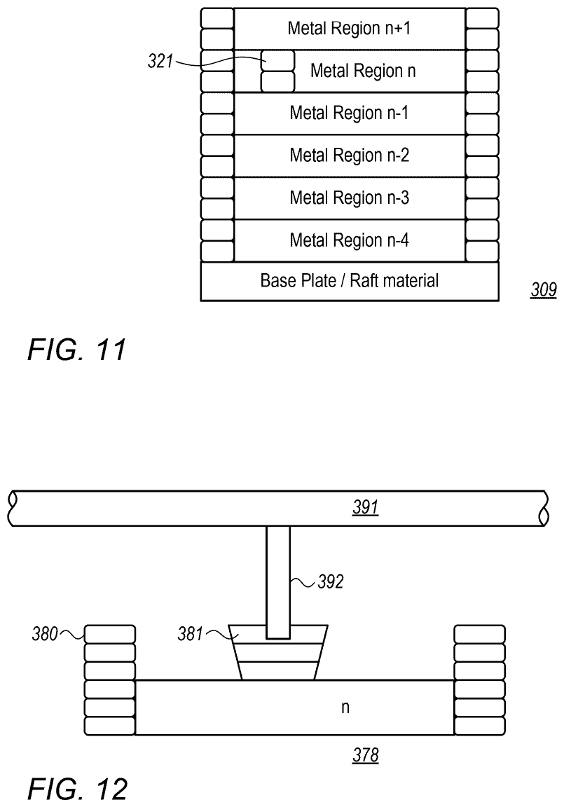

FIG. 12 illustrates an example of production phase 378 of mold construction of the n+1 production layer. A circumference mold region 380 and ‘mold over metal’ element 381 are shown. An overhead support 392 is shown. Overhead support 392 may be provided to engage with ‘mold over metal’ element 381 by support provision unit 391. Support provision unit 391 may travel over the building plane (not shown) on demand. Overhead support 392 may engage with ‘mold over metal’ element 381, e.g., using chemical binders. The combined structure of ‘mold over metal’ element 381 and overhead support 392 may be fully or partially cured. As a result, the position of ‘mold over metal’ element 381 is fixed. The fixing of the position of ‘mold over metal’ element 381 allows the ‘mold over metal’ element 381 to float over the molten metal without changing its position. Once the molten metal is cooled—the ‘mold over metal’ element 381 is still located at the desired location, and the overhead support 391 may be removed. The production of the next layer—production layer n+2, may start.

In embodiments employing in-situ deposition of viscous mold material, ‘mold over mold’ production scenarios may introduce additional molding process manufacturing constraints. After dispensing a first mold layer and before metal deposition, one or more additional mold layers may be dispensed. For example, three green state mold layers, each at 2 mm height, may be dispensed to generate a 6 mm-height cavity for receiving metal deposition. One or more additional mold layers may sag under their own weight.

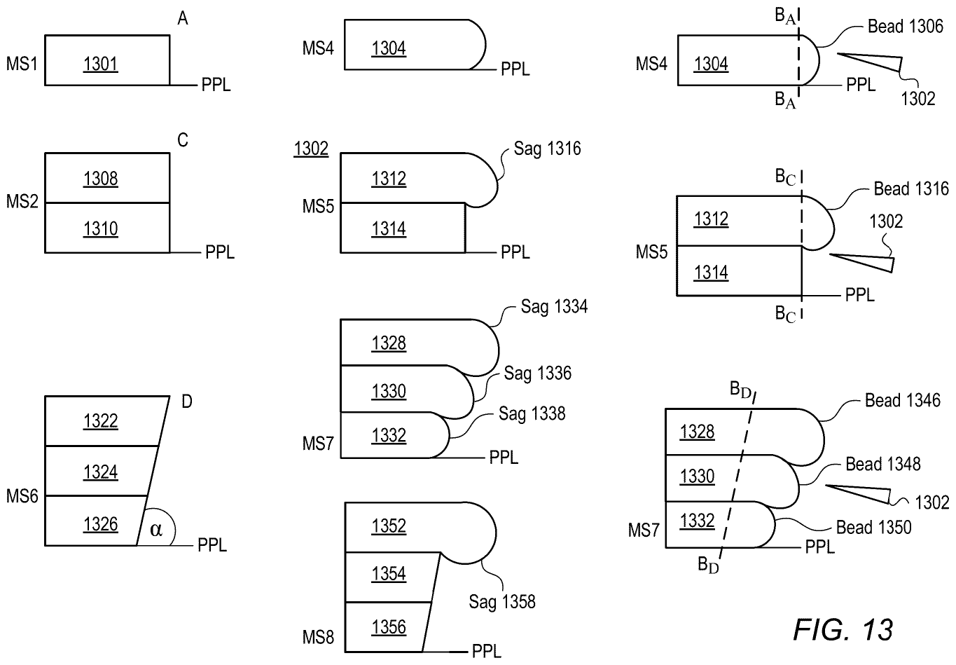

FIG. 13 illustrates cross sections of three ideal mold structures, MS1, MS2, and MS6, being part of mold regions required for the fabrication of respective desired object regions (not shown) at a certain production layer. The desired mold structure portion MS1 comprises, by way of example, a single desired mold layer 1301. Mold layer 1301 defines, by its metal-facing sidewall A and the upper surface of the previously-produced production layer PPL, a corresponding object region (not shown).

Mold structure portion MS4 illustrates an interim construction phase showing a single-layer mold region 1304 after its deposition and prior to surface treatment. Being made of a viscous material (e.g., ceramic-based green paste), a sag (bead) 1306 is inevitably created. Bead 1306 is removed by a surface treatment unit 1302 (e.g., a mechanical unit employing milling, grinding, and/or polishing) to thereby construct a mold region sidewall BA. Bead 1306 may be removed while the material of mold region 1304 is in the green state, partially cured or fully cured. Optionally, surface treatment debris may be collected by a cleaning unit (not shown). Once the mold region sidewall BA is complete, the construction of the current production layer may continue with metal processing.

Mold structure portion MS2 illustrates a desired two-layer mold region that would be constructed during two consecutive mold dispensing iterations, giving rise to desired mold layers 1308 and 1310 having a desired sidewall C. Mold structure portion MS5 illustrates an interim construction phase at which mold layer 1314 was dispensed and underwent surface treatment. Mold layer 1312 was dispensed on top of mold layer 1314. Sag (bead) 1316 is thus sagging below the interface between mold lines 1312 and 1314. In certain conditions depending, e.g., on mold layer height and mold material viscosity, the surface treatment unit may have limited maneuvering space and thus may not be able to adequately form mold region sidewall B_{c}. For example, the surface treatment unit may be constrained from milling the bottom part of bead 1316. This constraint may be resolved, e.g., by changing the order of operations, for example, by treating mold layers 1312 and 1314 together in a common surface treatment operation. Alternatively, the mold structure portion MS5 may be designed as a single-layer mold region with a larger height.

Mold structure portion MS6 illustrates a desired three-layer mold region that would be constructed during three consecutive mold dispensing iterations, giving rise to desired mold layers 1322, 1324, and 1326 having a desired sidewall D. Mold structure portion MS3 is inclined at a desired inclination angle α with respect to the surface of the previously-produced production layer PPL.

Mold structure portion MS7 illustrates an interim construction phase at which mold layers 1328, 1330, and 1332 were iteratively dispensed and commonly treated by surface treatment unit 1302 so that sidewall B_{D} is constructed by removing beads 1346, 1348, and 1350 (sags 1334, 1336, 1338 respectively). Depending on the inclination angle α and surface treatment-related constraints, the surface treatment unit may have limited maneuvering space and thus may not be able to adequately form mold region sidewall B_{D|}.

Mold structure portion MS8 illustrates an interim construction phase at which mold layers 1354 and 1356 were iteratively dispensed and separately treated by surface treatment unit 1302 so that sidewall B_{D} is partially constructed. Then, mold layer 1352 is dispensed with a certain shift on top of mold layer 1354, generating sag 1358. Depending on the inclination angle α and surface treatment-related constraints, mold layer 1352 may collapse under its weight due to a lack of support from under layer 1354.

In some embodiments, manufacturing constraints, as discussed with reference to FIG. 13, may be overcome, e.g., by adjusting the mold dispending plan (e.g., selecting a different mold dispensing nozzle), by affecting the mold paste minimal radius (for example, affecting paste viscosity), or selecting an appropriate milling unit. In some embodiments, the manufacturing limitation results in the generation of a compliant object. In some embodiments, the manufacturing limitation results in the identification of a non-feasible part of the desired object. An appropriate indication may be generated, for example, for a user. Alternatively, the identification of a part as non-feasible may be determined automatically.

FIG. 14 illustrates by way of a block diagram an example of an evaluation system 1000 being part of a casting system 1100. Evaluation system 1000 is illustrated in FIG. 14 as a module of the control system 1104. In other embodiments, the evaluation system may be realized as a stand-alone computerized system in data communication with casting system 1100, an object design system, or other systems (not shown).

The casting system may be an additive system that manufactures the object in an iterative manner—for example, one production layer (slice) after the other. The constraints of casting system 1100 may be taken into account during the execution of method 20 of FIG. 1 by the evaluation system 1000.

Casting system 1100 may comprise a mold construction system: mold depositor/s 1112 and mold deposition controller 1106 are shown. Casting system 1100 may comprise an object construction system: metal deposition device/s 1116 and metal deposition control 1128 are shown. Other components of the casting system (e.g., sensors, reservoirs, feeders, tubing, carriers, motion, gas, and the like) are not shown for simplicity.

The additive metal casting system 1100 fabricates a sequence of production layers 1202, one production layer after the other. In each production layer, the mold construction system constructs mold region/s 1204 defining a cavity (or cavities) (e.g., by mold depositors 1112), in which the object construction system constructs the respective object region/s 1206 (e.g., by metal deposition device 1116). Cavity 1205, the object region of production layer 1202-4, is shown during metal processing. Metal drops (or stream) 1212 are deposited into the object region 1205. The operation of mold construction is properly synchronized with operational cycles of the object construction to additively create the production layers, each including metal in an object region/s surrounded by a mold region/s. The object region/s are configured to receive molten metal being deposited by a molten metal depositor 1128.

The casting system 1100 may include inter alia a control system 1104 controlling the operation of one or more mold deposition devices 1112 and one or more surface treatment systems—one mechanical treatment system 1122 is shown. The control system 1104 is a computerized system, including inter alia a mold deposition controller 1106, a surface treatment controller 1108, and a metal-mold processes synchronizer circuit 1110.

The mold deposition device 1112 may be configured and operable by the mold deposition controller 1106 in accordance with a predetermined building plan of successive formation of multiple production layers. For each production layer formation, the mold deposition device 1112 performs one or more mold deposition iterations in each mold region 1204 prior to depositing the molten metal to form the object region 1206 of the current production layer.

The mold region may be a single-zone structure (as shown in FIG. 14) or a multi-zone structure (for example, as shown and discussed with reference to FIG. 7). In a multi-zone structure, one zone faces the metal (metal-facing zone), and one or more zones are non-metal adjacent zones. The metal-facing zone and the non-metal adjacent zones may differ in their material composition, dispensing manner, chemical and mechanical properties, and more.

Mold materials include mold materials in paste form, powder form, granular form, slurry form, and mold materials mixed with binders, releasing agents, activating agents, UV absorbing particles, crosslinking agents, heat-absorbing particles, or other additives to facilitate mold fabrication and use. According to embodiments of the invention, mold materials include but are not limited to, ceramics (e.g., zirconia, alumina, magnesia, etc.), sand, clay, metallic powders, and any combination thereof.

One or more metal deposition devices 1116 are controllably operable to deposit mold material to form the object region 1206, defined by the mold region/s 1204 in a production layer. The mold region defining the object region is configured to receive molten metal being deposited by a molten metal depositor 1116.

The metal depositor 1116 is configured and operable by mold deposition controller 1128 in accordance with a predetermined building plan of successive formation of multiple production layers. For each production layer formation, the metal depositor 1116 performs one or more metal deposition iterations in each of the object regions of the current production layer (after fabrication, the fabricated object regions are bonded and thus shown as object bulk 1206).

The casting system 1100 further includes one or more surface treatment systems configured and operable to apply one or more surface treatments to the mold material in the mold region, e.g., for smoothing, shaping, curing and the like. As an example, one or more heaters 1120 and mechanical surface treatment system 1122 are shown. UV heaters and laser heaters may be used (not shown).

In some embodiments, heaters 1120 are configured to provide surface treatment in the form of pre-deposition heating, and/or post-deposition heating is performed by heaters 1120. In some embodiments, one or more heaters 120 are physically coupled to the metal deposition device 1116.

The heating device 1120 is operable to apply temperature treatment to the mold material in the mold region to fully cure or partially cure the mold material. In some embodiments, heater 1120 may be configurable to apply the temperature treatment to the mold region after each of one or more mold deposition iterations.

The mechanical surface system 1122 may be configured to perform mechanical surface treatment of at least a portion of the mold region on surfaces of the mold region facing the object region or on surfaces of the object regions, e.g., milling, grinding, and/or polishing.

FIG. 14 further illustrates a cross-section view of a part of an object-and-mold structure 1205, which is formed by several successively deposited production layers 1202-0 to 1202-4.

The object-and-mold structure 1205 includes a metal object (bulk) 1206 within its mold structure (or part thereof) which is in the process of being additively cast on a build table 1210. The build table is configured to be placed in a temperature-controlled and protective environment (not shown here). Relative movement is provided between the build table 1210 and elements used for the fabrication of the production layers.

The relative movement along a progression direction defined by the building plan may be provided on command from the control system 1104 and can be realized side-to-side (in an x-direction 1224), front-to-back (in a y-direction), as well as up and down (in a z-direction 1220), and possibly also rotated clockwise and counterclockwise 1222 with respect to a coordinate system 1230. Typically, for casting large, unwieldy, and heavy objects, the displacement of the build table 1210 may be limited to relative movement in the z-direction.

In some embodiments, the build table 1210 is moved along the z-direction between the production layers in order to keep a working distance between the mold and metal depositors and the surface of the working area. In some embodiments, the build table 1210 is moved after the construction of the mold region and the production of the object region of the current production layer before the deposition of the mold region of the next production layer. In some embodiments, the x-y relative motion may be accomplished by moving the production elements while keeping the build table 1210 stationary.

Additive casting proceeds in accordance with a predetermined building plan of successive formation of multiple production layers (1202-0 to 1202-4). In the non-limiting example shown in FIG. 14, in production layers 1202-0 to 1202-3, both the mold construction and the metal casting are accomplished, whereas, in the current production layer (1202-4), molten metal 1212 is being deposited after the mold region 1204-4 of the current production layer was fabricated. Typically, one or more bottom production layers (e.g., 1202-0) are dedicated to mold material forming the lower surface for the successive production layers.

In this specific not limiting example, layers 1202-0 to 1202-4 include mold regions 1204-0 to 1204-4, wherein the bottom layer 1204-0 serves as the base layer, and the successive production layers (1204-1, 1204-2, 1204-3, and 1204-4) include the mold regions defining mold cavities forming the object regions for receiving molten metal. The mold regions 1204-0 to 1204-4 of layers 1202-0 to 1202-4 are shown with dotted lines representing the interfacing surfaces between them. This is to indicate that the mold regions of the production layers were fabricated at different production cycles and are in tight contact and adhere to one another.

For ease of explanation, only mold regions 1204-0 to 1204-4 forming the outer shape of the object regions (contours) are shown in FIG. 14. The invention is not limited to the illustrated design. Mold regions may form the so-called (in traditional casting) inserts, islands, bridges, and any other mold region shapes as defined by the building plan.

The principal operation of the mold region fabrication and metal region fabrication is carried out iteratively within the current production layer, in one or more locations (a single location is shown in the example of FIG. 14), by (sequentially) traveling the mold deposition device 1112 over the build table 1210 and additively dispensing the mold material(s) to form the mold region (e.g., 1204-4). Then, the metal depositor 1116 sequentially travels over the build table 1210 and additively deposits the molten metal to form the metal region. Metal region 1205 of the current production layer is shown. In some embodiments, pre-deposition heating is provided to thereby prepare a working area 1208 for receiving molten metal drops (or stream) 1212. In some embodiments, pre-deposition heating involves generating a melt-pool at the working area 1208. After metal deposition, the deposited metal solidifies and, together with previously-produced metal regions, forms object bulk 1206. In some embodiments, post-deposition heating is provided to thereby affect the cooling profile of the solidifying metal.

Both mold construction and metal construction may involve post-deposition treatments such as mold layer curing, mold upper and/or inner surface treatment, e.g., milling, grinding, polishing, assisted metal region solidification, metal surface treatment, e.g., milling, grinding, polishing, performed under the control of controller 1104.

According to an embodiment of the invention (not shown in FIG. 14), the casting system may include a molten metal reservoir, for example, a crucible. The casting system may include a metal feeding system, for example, for metal rods. According to an embodiment of the disclosure, the casting system may be configured to convert metal powder to molten metal. According to another embodiment of the disclosure, the metal casting system may be configured to convert metal rods, bars, or ingots to molten metal.

Various metal feed techniques, melting methods, and associated hardware elements may be used within the scope of this disclosure for the generation of molten metal that is applied by the metal casting system.

The evaluation methods and systems were described mainly with respect to the construction of the mold regions by selectively dispending viscous mold material in a green state (paste); the mold material may be fully cured, partially cured, or uncured before metal deposition.

The evaluation methods and systems are not limited by the type of mold construction technique. For example, in some embodiments, the mold regions may be formed by selectively dispending particles of one or more binding agents that bond some mold powder particles of a current mold powder layer. At least one part of the current mold powder layer is evacuated to allow the formation of one or more current object regions. In such embodiments, the mold deposition device 1112 may include additional mold depositor(s)/dispenser(s) to perform mold material deposition and dispense one or more special binding agents in selected regions via the binder jetting process. This process is followed by the removal of the mold powder from sites outside these regions, thus forming the arrangement of the relatively weak sites outside the regions containing the binding material.

Further, evaluation methods and systems are not limited to in-situ mold construction techniques. In some embodiments, mold frames constituting the mold regions are constructed ex-situ and are transferred, e.g., by a robot, one by one, for the respective production layer.

The evaluation methods and systems were described mainly with reference to the integration of the evaluation system with a casting system. The invention is not limited to this embodiment, and in some embodiments, the evaluation system can be implemented as a separate computerized system in data communication with a casting system or another system (e.g., an object design system). Further, the evaluation system can be implemented as a stand-alone computerized system that may receive, as input, information about casting system manufacturing constraints.

FIG. 15 schematically illustrates, by way of a block diagram, an exemplary computerized evaluation system 1500 for evaluating, e.g., for additive casting, a three-dimensional model of a desired object.

The exemplary evaluation system 1500 includes a processing system (processing device) 1502 configured to perform the operations and steps discussed herein, a memory device 1504 including, for example, the main memory (e.g., read-only memory (ROM), flash memory, dynamic random access memory (DRAM) such as synchronous DRAM (SDRAM)), a static memory (e.g., flash memory, static random access memory (SRAM)), and a data storage device which communicate with each other via a bus (not shown).

Processing device 1502 represents one or more general-purpose processing devices such as a microprocessor, central processing unit, or the like. More particularly, the processing device 1502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1502 may also be one or more special-purpose processing devices, such as an application-specific integrated circuit (ASIC), a field programmable gate array (FPGA), a digital signal processor (DSP), a network processor, or the like. In some embodiments, processing device 1502 is hosted by or integrated with a control system such as control system 1104 of FIG. 14. The evaluation system 1500 may further include a network interface device 1506. The evaluation system 1500 may also include an input/output device 1508 including, for example, a display unit (e.g., a liquid crystal display (LCD) or a cathode ray tube (CRT), not shown), an alphanumeric input device (e.g., a keyboard, not shown), a cursor control device (e.g., a mouse, not shown), and a signal generation device (e.g., a speaker, not shown).

A drive unit 1510 may include a computer-readable medium 1512 on which is stored one or more sets of instructions embodying any one or more of the methods, methodologies, or functions described herein (evaluation module 1514). The instructions may also reside, completely or at least partially, within the memory and data storage 1504 and/or within the processing device 1502. During execution thereof by the evaluation system 1500, the memory and data storage 1504 and the processing device 1502 also constitute computer-readable media. The instructions may further be transmitted or received over a network via the network interface device 1506.

While the computer-readable storage medium 1512 (including the evaluation module 1514) is shown in an exemplary embodiment to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, carrying, or being programmed with a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

Numerous specific details are outlined in the detailed description in order to provide a thorough understanding of the invention. However, it will be understood by those skilled in the art that the present invention may be practiced without these specific details. In other instances, well-known methods, procedures, and components have not been described in detail to obscure the present invention.

Because the illustrated embodiments of the present invention may, for the most part, be implemented using electronic components and circuits known to those skilled in the art, details will not be explained to any greater extent than that considered necessary, as illustrated above for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer-readable medium that stores instructions that, once executed by a computer, result in the execution of the method.

Any reference in the specification to a system should be applied mutatis mutandis to a method that may be executed by the system and should be applied mutatis mutandis to a non-transitory computer-readable medium that stores instructions that may be executed by the system.

Any reference in the specification to anon-transitory computer-readable medium should be applied mutatis mutandis to a system capable of executing the instructions stored in the non-transitory computer-readable medium and should be applied mutatis mutandis to a method that may be executed by a computer that reads the instructions stored in the non-transitory computer-readable medium.

As used throughout the specification, the terms “metal” or “metallic” refers to any metals and/or mellitic alloys which are suitable for melting and casting, for example, ferrous alloys, aluminum alloys, copper alloys, nickel alloys, magnesium alloys, and the like. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

The invention may also be implemented in a computer program for running on a computer system, at least including code portions for performing operations and stages of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions, such as a particular application program and/or an operating system. The computer program may, for instance, include one or more of: a subroutine, a function, a procedure, an object method, an object implementation, an executable application, an applet, a servlet, a source code, an object code, a shared library/dynamic load library and/or other sequences of instructions designed for execution on a computer system.

The computer program may be stored internally on a non-transitory computer-readable medium. All or some of the computer programs may be provided on computer-readable media permanently, removably, or remotely coupled to an information processing system. The computer-readable media may include, for example, and without limitation, any number of the following: magnetic storage media, including disk and tape storage media; optical storage media, such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may, for instance, include at least one processing unit, associated memory, and one or more input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under”, and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary and that, in fact, many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected” or “operably coupled” to each other to achieve the desired functionality.

Furthermore, those skilled in the art will recognize that boundaries between the above-described operations are merely illustrative. The multiple operations may be combined into a single operation; a single operation may be distributed in additional operations, and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within the same device. Alternatively, the examples may be implemented as any number of separate integrated circuits or separate devices interconnected with each other in a suitable manner.

Also, for example, the examples, or portions thereof, may be implemented as soft or code representations of physical circuitry or of logical representations convertible into physical circuitry, such as in a hardware description language of any appropriate type.

Also, the invention is not limited to physical devices or units implemented in non-programmable hardware but can also be applied to programmable devices or units able to perform the desired device functions by operating in accordance with suitable program code, such as mainframes, minicomputers, servers, workstations, personal computers, notepads, personal digital assistants, electronic games, automotive and other embedded systems, cell phones, and various other wireless devices, commonly denoted in this application as ‘computer systems’.

However, other modifications, variations, and alternatives are also possible. The specifications and drawings are, accordingly, to be regarded in an illustrative rather than in a restrictive sense.

The subject matter regarded as the invention is particularly pointed out and distinctly claimed in the concluding portion of the specification. The invention, however, both as to organization and method of operation, together with objects, features, and advantages thereof, may best be understood by reference to the detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or operations and stages than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for evaluating a three-dimensional (3D) model of a desired object based on casting system manufacturing constraints, the method comprises:
obtaining the 3D model of the desired object; wherein the 3D model comprises vertexes and angular information regarding angular relationships between the vertexes;
virtually partitioning the 3D model into slices;
generating a 3D model of a casting system-compliant object; wherein the generating comprises determining for each slice, based on casting system manufacturing constraints and on the 3D model of the desired object, (a) one or more mold regions associated with the slice, and (b) one or more object regions defined by the one or more mold regions, to be formed by molten metal processing; and
responding to the generating of the 3D model of the casting system-compliant object.

2. The method according to claim 1, wherein the casting system manufacturing constraints comprise at least one out of molding process constraints, mold machining constraints, or molten metal constraints.

3. The method according to claim 2, wherein the mold machining constraints comprise milling process constraints.

4. The method according to claim 3, wherein the milling process constraints comprise one or more constraints from a group consisting of (1) milling device accessibility constraints and (2) milling device size constraints.

5. The method according to claim 2, wherein the molten metal constraints comprise one or more constraints from a group consisting of (1) a dimension of a drop of molten metal, (2) an area of a spread of a drop of the molten metal, (3) a dimension of a stream of molten metal, and (4) feasible trajectories of a stream of molten metal.

6. The method according to claim 2, wherein the mold constraints comprise one or more constraints from a group consisting of (1) viscosity of mold material, (2) shape constraints of mold material, (3) binding agents selective deposition constraints; mold powder particles provision constraints, (4) mold powder removal constraints, (5) mold material deposition constraints.

7. The method according to claim 1, wherein the casting system manufacturing constraints comprise at least one out of (1) molding process voxel constraints, (2) mold voxel machining constraints, and (3) molten metal voxel constraints.

8. The method according to claim 1, wherein the casting system manufacturing constraints comprises voxel size and orientation constraints.

9. The method according to claim 8, wherein the determining comprises finding that a facet that is located at a certain location and is formed by a set of vertexes of the 3D model does not comply with an orientation constraint of voxel located at a corresponding certain location.

10. The method according to claim 9, wherein the finding of the facet is followed by evaluating whether the facet can be manufactured by the casting system by (a) dispensing mold to the voxel that is located at the corresponding certain location, (b) removing excess material from the voxel to provide a partial voxel, and (c) providing molten metal to a gap formed by the removing of the excess material.

11. The method according to claim 1 comprises detecting non-manufacturable 3D model elements that cannot be manufactured under the casting system manufacturing constraints.

12. The method according to claim 11, wherein the responding comprises generating an alert regarding the detecting non-manufacturable 3D model elements.

13. The method according to claim 11 comprises compensating for the non-manufacturable 3D model elements.

14. The method according to claim 11 comprises ignoring the non-manufacturable 3D model elements.

15. The method according to claim 1, wherein the responding comprises generating difference information between the 3D model of the desired object and the 3D model of the casting system-compliant object.

16. The method according to claim 1, wherein the responding comprises storing the 3D model of the casting system-compliant object.

17. A non-transitory computer-readable medium for evaluating a three-dimensional (3D) model of a desired object based on casting system manufacturing constraints, the non-transitory computer-readable medium stores instructions for:
obtaining the 3D model of the desired object; wherein the 3D model comprises vertexes and angular information regarding angular relationships between the vertexes;
virtually partitioning the 3D model into slices;
generating a 3D model of a casting system-compliant object; wherein the generating comprises determining for each slice, based on casting system manufacturing constraints and on the 3D model of the desired object, (a) one or more mold regions associated with the slice, and (b) one or more object regions defined by the one or more mold regions, to be formed by molten metal processing; and
responding to the generating of the 3D model of the casting system-compliant object.

18. The non-transitory computer-readable medium according to claim 17, wherein the determining comprises finding that a facet that is located at a certain location and is formed by a set of vertexes of the 3D model does not comply with an orientation constraint of voxel located at a corresponding certain location, the finding is followed by evaluating whether the facet can be manufactured by the casting system by (a) dispensing mold to the voxel that is located at the corresponding certain location, (b) removing excess material from the voxel to provide a partial voxel, and (c) providing molten metal to a gap formed by the removing of the excess material.

19. A computerized evaluation device for evaluating a three-dimensional (3D) model of a desired object based on casting system manufacturing constraints, the computerized evaluation device comprising a memory; and a processing device coupled to the memory, the processing device to perform operations comprising:
obtaining the 3D model of the desired object; wherein the 3D model comprises vertexes and angular information regarding angular relationships between the vertexes;
virtually partitioning the 3D model into slices;
generating a 3D model of a casting system-compliant object; wherein the generating comprises determining for each slice, based on casting system manufacturing constraints and on the 3D model of the desired object, (a) one or more mold regions associated with the slice, and (b) one or more object regions defined by the one or more mold regions, to be formed by molten metal processing; and
responding to the generating of the 3D model of the casting system-compliant object.

20. The device according to claim 19, the determining comprises finding that a facet that is located at a certain location and is formed by a set of vertexes of the 3D model does not comply with an orientation constraint of voxel located at a corresponding certain location, the finding is followed by evaluating whether the facet can be manufactured by the casting system by (a) dispensing mold to the voxel that is located at the corresponding certain location, (b) removing excess material from the voxel to provide a partial voxel, and (c) providing molten metal to a gap formed by the removing of the excess material.
